(19) United States
(12) Patent Application Publication
(10) Pub. No.: US 2011/0108241 A1
(43) Pub. Date: May 12, 2011

(54) METHOD FOR MAKING PHASE CHANGE PRODUCTS FROM AN ENCAPSULATED PHASE CHANGE MATERIAL

(76) Inventors: Joseph A. Driscoll, Honey Creek, IA (US); Joseph B. Parker, Longmont, CO (US)

(21) Appl. No.: 12/760,818

(22) Filed: Apr. 15, 2010

Related U.S. Application Data
(63) Continuation-in-part of application No. 12/356,144, filed on Jan. 20, 2009.

(51) Int. Cl. F28D 15/00; C09K 5/00

(52) U.S. Cl. 165/104.21; 252/71; 252/73; 252/77

(57) ABSTRACT

The present invention provides methods of producing manufactured aggregates and other compositions from an encapsulated PCM slurry, suspension or emulsion by combining a cementitious binder and an adsorbent and/or absorbent with the PCM slurry. The encapsulated PCM can be introduced as damp cake or dry form as alternatives to the liquid forms. Fire resistant aggregates can be produced in an agglomeration process. The ingredients can also be mixed to form a viscous mass which can be extruded or otherwise formed to produce useful products.

### CROSS REFERENCE APPLICATIONS

This application is a continuation-in-part claiming benefits utility application Ser. No. 12/356,144, filed Jan. 20, 2009.

### FIELD OF INVENTION

The present invention relates generally to the field of cementitious aggregates or a viscous mass for extrusions, and more particularly to aggregates or extrusions with significant thermal storage capacity formed by the mixing or agglomeration of encapsulated phase change materials (e.g., in a liquid emulsion, suspension or slurry) with a cementitious binder and an adsorbent and/or absorbent material.

### BACKGROUND OF THE INVENTION

### Description of Related Art

Phase change materials (PCM) are thermal storage materials that are capable of storing large amounts of thermal energy that can be useful in moderating daytime nighttime temperature fluctuations. At present a great deal of interest and markets exist for PCM. Well engineered lightweight structures utilizing PCMs typically reduce cycling of heating and cooling machinery and cause the buildings temperatures to more closely remain in the comfort zone for occupants. It is sometimes beneficial to incorporate PCM into building materials and other products, but all known methods of doing so require that encapsulated PCM be mixed directed into the mix of the end product. PCMs can be hydrated salts, plastic crystals, hydrated salts with glycols or hydrocarbon waxes. Ciba Specialty Chemicals' U.S. Pat. No. 6,716,526 and BASF U.S. Pat. No. 6,200,681 describe manufacturing processes for making microencapsulated hydrocarbon wax phase change particles. The manufacturing process of mPCM produces an aqueous emulsion that contains both solids and liquids. The solids portion, typically 42 to 48 weight percent, are PCM wax particles encased by an acrylic shell. The liquid portion contains from 58 to 52 weight percent water with wax and acrylics residues not bound up to the solids in the production process. In the past, it has been necessary to remove the encapsulated PCM solids from the acrylics dispersion in the slurry by a costly drying process to effectively incorporate encapsulated PCM into most other products.

An obstacle to the acceptance of PCM in building materials has been that PCM is inherently flammable. The PCM itself is generally a hydrocarbon, typically a paraffin, that burns very easily. The PCM capsule material, whether a polymer acrylic, melamine/formaldehyde, or some other material, is also inherently flammable.

There are a number of processes in the prior art for making encapsulated PCM and for the use of PCM in concrete, wallboard, insulation, and other building products.

U.S. Pat. No. 4,747,240, issued May 31, 1988 for Encapsulated PCM Aggregate to Voisinet et al., describes a process in which PCM as an admixture is incorporated directly into a variety of cementitious interior building materials. In that patent, both microencapsulated PCM or “form stabilized”, non-encapsulated PCM, is incorporated directly as an aggregate into a cementitious composition. That patent does not contemplate an aggregate of various sizes, but describes the encapsulated PCM particles themselves as aggregate.

Similarly, U.S. Pat. No. 7,166,355, issued Jan. 23, 2007 for Use of Microcapsules in Gypsum Plaster Board to Jahns et al., discusses a process wherein microencapsulated PCM is incorporated directly into cementitious building material, i.e., wallboard core and plasterboard. This patent states that special steps must be taken to insure the bonding of all components because of the poor bonding nature of the microencapsulated PCM particles.

### SUMMARY OF THE INVENTION

The primary aspect of the present invention is to provide a method of manufacturing engineered phase change aggregates or extrudite directly from typical aqueous PCM emulsions by combining a cementitious binder with the slurry in an agglomeration or mixing/extrusion process that bypasses or eliminates the costly spray drying process. The invention also provides types of fast setting cements and an adsorbent and/or absorbent material that bind up a high percentage of the water in the aqueous PCM fluid and set fast enough to allow a continuous PCM production process. The composition in aggregate form then goes through a curing and classification process to meet the size criteria of the end product. If the composition is a viscous mass, then the composition goes through an extrusion process which matches the application. The invention also provides a method of manufacturing a PCM composition that is substantially fire retardant.

Embodiments of the present invention include processes for the production of fire resistant phase change material (PCM) materials, generally comprising initial steps of providing at least one PCM in encapsulated form, then combining same with a cementitious binder and an adsorbent and/or absorbent material. Encapsulated PCMs are available in a variety of melting points and particle sizes, including microencapsulated versions (mPCM), and can be provided as a substantially dry powder, a damp cake or an aqueous slurry, suspension or emulsion. Depending upon the type of PCM used, aqueous liquids may be added while the ingredients are admixed to form a viscous mass which is a fire resistant PCM material. The proportions should be effective to provide sufficient plasticity in the viscous mass to permit further processing, such as extrusion, before the material begins to set. The proportions of the principal ingredients can be (as weight percent):
Aqueous liquid from about 30 to about 60
PCM solids (including capsule materials)—from about 25 to about 90;
cementitious binder—from about 0.25 to about 20, and
absorbent and/or adsorbent—from about 5 to about 50.

Regardless of the type(s) of PCM and the amount of aqueous liquid added to the formula, the final moisture content of the viscous mass produced by mixing all ingredients should be in the range of from about 30 to about 60 weight percent. By “final moisture content” it is meant the total moisture content of the viscous mass before drying and/or hardening take place. The amount of absorbent and/or adsorbent can be from about one times to about six times the weight of the cementitious binder. In separate embodiments, the ingredients can be combined in an agglomerator or pelletizer to form PCM aggregate particles which have many uses and can be produced and processed to obtain aggregates having a wide range of average sizes and particle size distributions. Preferably, the aggregate particles have a non-respirable minimum size of about 20 microns. The viscous mass can have an enthalpy in the range of from about 35 to about 250 Joules/gram. In another embodiment the aqueous liquid encapsulated PCM slurry or emulsion with a viscosity of about 200 mPa.s is combined with the cementitious binder and an adsorbent or absorbent. When the combined ingredients are subjected to vigorous mixing, a fire resistant viscous mass quickly forms. This viscous mass may be described as a non Newtonian semi-solid that can hold peaks and has the initial consistency of peanut butter or shortening. The viscous mass while in a plastic state prior to setting and hardening is suitable for shaping into products through an extrusion apparatus. Using this process, the PCM composition can be extruded into extrudites having various shapes including flat layers of various sizes and thicknesses. Such layers can be extruded directly onto flat substrates of various types, where they may adhere to impart PCM properties to the substrate material. Whether producing aggregate or extrudite products, the processes can be operated for continuous production or as batch processes.

Various commercially available PCMs can be employed in these embodiments, including hydrocarbon liquids or waxes, natural or synthetic waxes, metal inorganic salts containing waters of hydration, and certain crystalline polymer materials, as described in detail herein. These PCMs are preferably encapsulated in shells of suitable sizes and materials. The present invention more generally relates to hydrocarbon waxes. Materials which have been successfully tested include hydrocarbon PCM encapsulated in shells comprising polymers such as acrylics or melamines, some of which are commercially available from Ciba/BASF and other sources as described elsewhere herein. Encapsulated PCM which have average diameters in the range of from about one micron to about 3 mm, can be used with those having diameters in the range of from about one micron to about 100g being considered “microencapsulated” PCM.

A wide variety of cementitious binders can be used, including Portland cements, plaster of Paris, silicate cements, and various acid-base cements as described in detail elsewhere herein. Adsorbent and/or absorbent materials are employed to take up excess water and allow the compositions to achieve the desired moisture content which is effective to produce the desired viscosity and other properties. Various clay minerals can be used, including attapulgite or palygorskite. The attapulgite or palygorskite is preferably purified to remove grit and non-attapulgite clays, and can have particle sizes smaller than about 100 mesh. In this invention, combinations of the preferred acid-base cement and purified attapulgite clay have been observed to be effective fire retardants. U.S. Pat. No. 7,247,263 discloses purified attapulgite as major part of a fire-barrier composition.

In addition to the fire retardant qualities produced by combining the above materials to produce PCM aggregates or extrudites, the fire resistant qualities of these products may be enhanced by incorporating fire retardants such as magnesium and/or aluminum hydroxides.

The PCM aggregates and extrudites disclosed herein can be employed in a variety of ways, including addition in particulate form to various insulative materials or extruded onto the surface of planar insulating materials. PCM aggregates can be incorporated into various concrete products and used in heat exchanger apparatus by packing into cylindrical columns or suitable arrangement in ducts for heat exchange with flowing gases or liquids.

Other aspects of this invention will appear from the following description and appended claims, reference being made to the accompanying drawings forming a part of this specification wherein like reference characters designate corresponding parts in the several views.

### BRIEF DESCRIPTION OF THE DRAWINGS

These and other attributes of the invention will become more clear upon a thorough study of the following description of the best mode for carrying out the invention, particularly when reviewed in conjunction with drawings, wherein:

FIG. 1 is a flow diagram of a process for production of a fire resistant PCM viscous mass which can be fashioned into numerous forms such as an aggregate, multiple extruded shapes, or self bonded directly to material such as insulation foam board.

FIG. 2 is a flow diagram of a process for manufacturing PCM aggregate material which is integrated into a production process for encapsulated PCM.

FIG. 3 is a flow chart of a process for production of a PCM aggregate.

FIG. 4 is a flow diagram of a process for production of a fire resistant PCM extruded viscous mass.

FIG. 5a and FIG. 5b are sectional views of PCM aggregate in use within an air to air heat exchanger.

FIG. 6a and FIG. 6b are sectional views of liquid/gas PCM aggregate heat exchangers, charging and discharging, respectively.

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

### DETAILED DESCRIPTION OF THE DRAWINGS

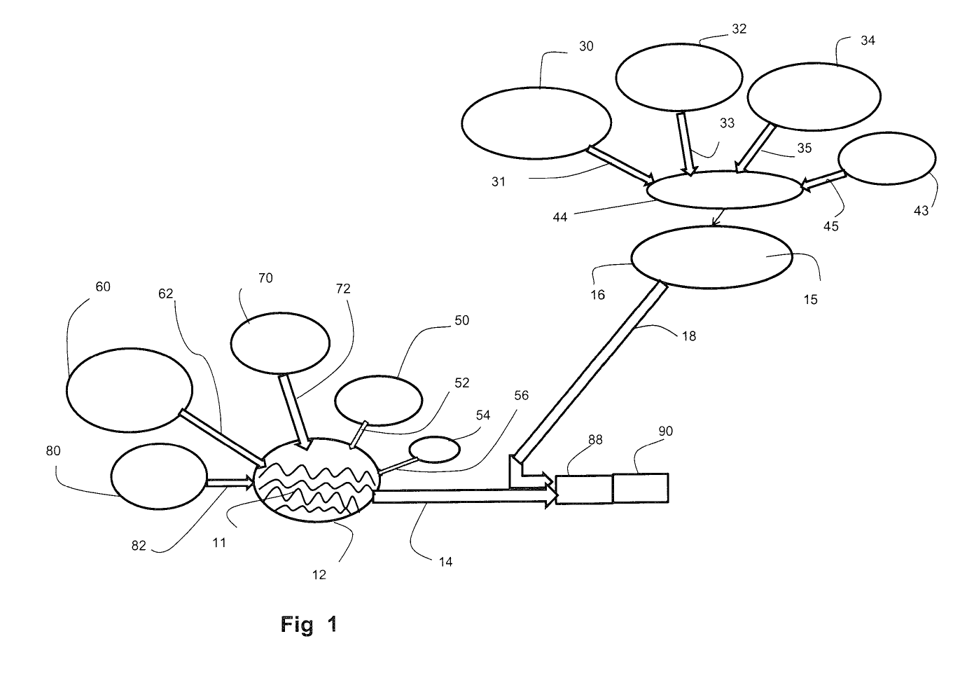

As can be seen by reference to the drawings, and the following Examples, the method that forms the basis of an embodiment of the present invention is generally illustrated in the flow diagram of FIG. 1, which is discussed below along with the other figures. In the following description and the examples, all percentages are by weight unless otherwise indicated. The term “A and/or B” is used in the conventional sense, meaning that A, B or A+B may be present.

Definitions:

Acid-Base Cement—A class of cements formed by reaction of an acid with a base at room temperature which exhibit properties like those of ceramics. Identified as Chemically Bonded Cements (CBC).

Chemically bonded phosphate ceramics (CBPCs)—a subclass of CBCs generally formed by the reaction of metal oxides such as those of magnesium or zinc, with either phosphoric acid or an acid phosphate such as ammonium phosphate solution.

Absorption: the penetration of one substance into the inner structure of another, as with cotton or sawdust absorbing a liquid.

Adsorption: the adherence of the atoms, ions or molecules of a gas or liquid to the surface of another substance (the adsorbent). Finely divided or microporous materials presenting a large area of active surface are strong adsorbents.

Both absorbents and adsorbents can be useful in preparing compositions of the present invention, and some materials, e.g. clay minerals containing mixtures of clay types, can perform both functions.

Agglomeration: a size enlargement process by which smaller particles are made into larger particles by briquetting, pelletizing, extruding, agglomerating, or other size enlargement methods. Some agglomerators are disclosed in U.S. Pat. Nos. 4,599,321; 7,632,006 and 4,504,306, all of which are incorporated herein by reference. Commercially available agglomerators include the O′Brien Agglomerator, available from Engineering and Design Associates, Inc. of Folsom, Calif. Both agglomerators and pelletizers are offered by Mars Mineral of Mars, Pa.

Aggregates: materials of various shapes, sizes and compositions capable of being bound together with other such materials by cement. In the construction and other industries, aggregates are generally divided into fine (e.g., sand) and coarse (e.g., gravel) categories.

Manufactured aggregates: material produced by mixing, agglomeration and curing with properties that meet with specifications of the concrete or other composition in which it will be incorporated.

Aqueous liquid: any water-based liquid, including slurries, suspensions, solutions and emulsions.

Clay minerals: a family of materials classified as hydrous aluminum phyllosilicates, sometimes containing variable amounts of iron, magnesium, alkali metals, alkaline earth metals and other cations. Clays have structures similar to the micas, forming flat hexagonal sheets. Clays are generally ultra fine grained, and are commonly referred to as 1:1 or 2:1 types. Clays are essentially built of tetrahedral and octahedral sheets. The tetrahedral sheets share corners of silicate (SiO₄) and aluminate (AlO₄) groups, and thus have the overall chemical composition (Al,Si)₃O₄. These tetrahedral sheets are bonded to octahedral sheets formed from small cations, such as aluminum or magnesium, coordinated by six oxygen atoms. A 1:1 clay would contain one tetrahedral sheet and one octahedral sheet; examples are kaolinite and serpentine. A 2:1 clay contains an octahedral sheet sandwiched between two tetrahedral sheets, examples being illite, smectite, attapulgite and chlorite. Clay minerals can be divided into the following groups:

Kaolin group: kaolinite, dickite, hallowsite and nacrite, sometimes including the serpentine group;

Smectite group: dioctahedral smectites such as montmorillonite and nontronite and trioctahedral smectites such as saponite;

Illite group, including the clay-micas;

Chlorite group: materials similar to chlorite, with chemical variations;

Other 2:1 clays with long water channels internal to their structure such as sepiolite, attapulgite and palygorskite.

Desiccant: hygroscopic substances such as activated alumina, calcium chloride, silica gel or zinc chloride which absorb water vapor from the air; such functions can also be performed by molecular sieves.

Mixing: a process step to blend feed stocks to form a feed mix prior to agglomeration. Ideally, mixing causes particles of the feedstocks to come into close proximity to one another and particles of the feedstocks become uniformly distributed throughout the feed mix.

Extrusion: a process of forming a plastic material or viscous mass by forcing it under pressure through an extrusion head or other forming apparatus. Extrudite: a formed material produced by extrusion.

Feedstocks: materials that are blended together by mixing. In embodiments of this invention, the term includes (a) PCM particles; (b) any other materials that are not PCM particles, but were part of the PCM manufacturing process (e.g., the fluid portion of a slurry or emulsion, the acrylic or melamine/formaldehyde polymers comprising the capsule of PCM, and other matter left over from production processes contained in the slurry or emulsion, etc.), and (c) the cement binder, adsorbent or absorbent materials, and combinations thereof, as well as any other material added to solidify and improve the qualities of the feed mix and the aggregate or extrudite that will be made from the feed mix.

Feed Mix: mixture of PCM and other feedstocks, (and water or surfactants where required,) prior to agglomerating or other processing.

Cement: any combination of inorganic materials that can act as a bonding agent to bind other materials together into a hardened mass (e.g. Portland Cement, plaster of Paris, silicate cements, magnesium phosphate cements, magnesium oxychloride cements, magnesium oxysulfate cements, etc.). Also, a cured composition comprising such cement(s).

Cementitious: a term descriptive of anything made up of materials bound together in a hardened mass of cement. Also a cementitious binder used to bind materials together.

Concrete: a mixture of aggregates and cement plus sufficient liquid, which can cure and harden into a finished solid form.

End Product: whatever is to be manufactured. In this case, where building materials are the end product, the term includes, but is not limited to, bricks, blocks, boards, wall tiles, paving, ceiling materials (ceiling tiles, etc.), flooring (floor tiles, underlayment, etc.), concrete articles, mortars, renders, plasters, cements, room furnishings, heating and cooling ductwork, and insulation products.

Fibrous reinforcements: Any form of short, fine fibers which can be admixed with the viscous mass containing encapsulated PCM which is used to produce various embodiments of PCM aggregates and extrudites. The fibers can be made from inorganic materials such as metals or glass, carbon or ceramics, and various organic polymer materials such as polypropylene. Suitable polypropylene fibers are produced by PROPEX Concrete systems as FIBERMESH® 150. Such fibers can be chopped or milled.

Fire Resistant/Fire Retardant: “fire resistant” and “fire retardant” are sometimes used interchangeably but imply a subtle difference in fire properties. In this invention, we define fire or flame retardant to mean a material that resists burning or burns slowly and fire resistant to mean a material that resists burning to the extent it can act as a fire barrier. Varying degrees of fire resistance are defined in safety codes and are capable of objective measurement.

Magnesium oxide, MgO, magnesia: available in several different forms, ranging from a lighter material prepared in a relatively low calcination temperature dehydration of the hydroxide to a more dense material made by higher temperature furnacing or calcination of the oxide after it has been formed from the carbonate or hydroxide. Thermal alteration affects the reactivity of MgO, since less surface area and pores are available for reaction with other compounds. Industrial versions include light burned and hard burned or dead burned MgO. High purity MgO may be rehydrated to form a slurry of magnesium hydroxide.

PCM: phase change material(s) are heat storage materials that act as thermal mass. The principle behind PCM is that the materials' latent heat of fusion is substantially greater than its sensible heat storing capacity (i.e., the amount of heat that the material absorbs when melting, or releases when freezing or hardening, is much greater than the amount of heat that the material absorbs or releases by cooling or heating when undergoing the same amount of temperature change in ranges below and above the phase change temperature.) As used herein for certain embodiments, PCM refers to the wax or other hydrocarbon that comprises such material in a particulate form, by which is meant encapsulated and provided in bulk in a powder, slurry, cake, or emulsion

Some suitable paraffinic hydrocarbon phase change materials are shown below in the following table which indicates the number of carbon atoms contained in such materials, which is directly related to the melting point of such materials.

| | | MELTING |
|---|---|---|
| COMPOUND | NUMBER OF | POINT |
| NAME | CARBON ATOMS | CENTRIGRADE |
| n-Octacosane | 28 | 61.4 |
| n-Heptacosane | 27 | 59.0 |
| n-Hexacosane | 26 | 56.4 |
| n-Pentacosane | 25 | 53.7 |
| n-Tetracosane | 24 | 50.9 |
| n-Tricosane | 23 | 47.6 |
| n-Docosane | 22 | 44.4 |
| n-Heneicosane | 21 | 40.5 |
| n-Eicosane | 20 | 36.8 |
| n-Nonadecane | 19 | 32.1 |
| n-Octadecane | 18 | 28.2 |
| n-Heptadecane | 17 | 22.0 |
| n-Hexadecane | 16 | 18.2 |
| n-Pentadecane | 15 | 10.0 |
| n-Tetradecane | 14 | 5.9 |
| n-Tridecane | 13 | −5.5 |

In addition to the paraffinic hydrocarbons described above, plastic (polymeric) crystals such as DMP (2,2-dimethyl-1,3-propanediol) and HMP (2-hydroxymethyl-2-methyl-1,3-propanediol) and the like may be used as temperature stabilizing materials.

When plastic crystals absorb thermal energy, the molecular structure is temporarily modified without changing the phase of the material. Plastic crystals may be employed alone or in combination with other temperature stabilizing materials in any of the configurations described herein.

Hydrated salts: Metal inorganic salts with waters of hydration, such as Glauber's salt (sodium sulfate decahydrate, with energy storage capacity seven times that of water), calcium chloride hexahydrate and sodium carbonate are also useful as PCMs.

Waxes: Numerous petroleum-based, natural and synthetic waxes can be used in PCMs, the selections based mainly upon cost, availability and thermal properties. In addition to hydrocarbons such as described above, some waxes are esters of fatty acids and alcohols. Natural waxes include those derived from animals (e.g., beeswax, lanolin, shellac wax and Chinese insect wax), vegetables (carnauba, candelilla, bayberry and sugar cane) and minerals (e.g., ozocerite, ceresin and montan). Synthetic waxes include ethylenic polymers and polyol ether-esters such as Carbowax® and sorbitol, chlorinated naphthalenes, sold as Halowax®, hydrocarbon-type waxes produced via Fischer-Tropsch synthesis and polymethylene waxes. The paraffins or aliphatic hydrocarbons described above can also be chlorinated to alter their properties.

Encapsulated PCM: encapsulated phase change material. PCM is encapsulated so it will remain in place while in its liquid phase. Encapsulation typically takes place in a process wherein PCM, in liquid phase, is contained within a temperature controlled fluid medium that also contains a material that will form the “shell” or “capsule” for the PCM, as well as other materials required for the production process. A physical and/or chemical action takes place within the fluid medium which causes microscopic particles of liquid PCM to be formed within a thin layer of shell material. The shell material, which has a higher phase change temperature, hardens around the tiny particles of liquid PCM, and as the medium cools further, the encased PCM particles also become solid. After the process, the particles are generally referred to as encapsulated PCM, The particles are generally referred to as encapsulated PCM. These are contained in a slurry or suspension (i.e., the fluids used in the manufacturing process and the PCM particles) that generally contains from 35% to 65% PCM solids.

Plasticizer, superplasticizer: compounds used in cement, concrete and the like to reduce free water and make the mixtures more fluid to increase their workability. Compounds used for various applications include synthetic sulfonates and polycarboxylates, sulfonated naphthalenes, melamine polysulfonates and 2-Acrylamido-2-methylpropane sulfonic acid.

Residence time: The amount of time a particle or specific volume of liquid dwells within a continuous mixing or agglomerating machine. The time lapse between specific particle or liquid inflow and outflow. Residence time in embodiments of this invention is controlled by the rate of inflow of dry feeds and liquid feeds.

Commercially available dry mPCM when incorporated in cementitious building materials has many drawbacks. The microscopic particle size increases water demand beyond typical water/cement ratios and special precautions must be taken to avoid inhaling the particles. U.S. Pat. No. 6,099,894 mentions these precautions. Acrylics and other chemical residues retard set times. Scanning Electron Micrographs show that encapsulated PCM interferes with crystalline and amorphous structure formation in Portland cement, gypsum plasters and acid/base cements. The acrylic shell material has poor bonding qualities when incorporated in typical cements used in building products. European Published Patent Application No. EP0344013 discloses that the PCM particles reduce concrete strength and interfere with crosslinking Dry encapsulated PCM can be added, for example, directly into a cement mix or to other ingredients in a process for manufacturing other cementitious materials. U.S. Pat. No. 5,804,297, for example, discloses a method for incorporating dry microencapsulated PCM into a coating which is said to provide thermal insulation and latent heat storage characteristics to the underlying material. Similarly, U.S. Pat. No. 7,166,355 discloses a method for incorporating dry microencapsulated PCM into a wet plaster mix used in making wallboard. In each of these cases, dry microencapsulated PCM is directly incorporated into the end product, with no effective fire resistance being imparted to the PCM material. In each case, the end product would be a greater fire hazard with the PCM, which is highly flammable, than without it.

Neither of these methods addresses the health hazards associated with the handling of dry encapsulated PCM. Neither deals with the flammability characteristics of PCM, nor is the use of encapsulated PCM in the form of slurry or cake, or is a non-microencapsulated form even suggested.

By incorporating PCM into an aggregate, fire resistant qualities may be introduced by selection of the feedstock materials that are mixed with the PCM in the process of preparing the PCM aggregate or extrudite.

Depending on which cement system (hydraulic, silicate, or acid- base) is used, the encapsulated PCM particles will be contained within matrices of the three dimensional amorphous agglomeration formed by the cement and other materials comprising the hardened mix. The cross linking is not that of the encapsulated PCM particles; rather, it is the cement hardening into a three dimensional agglomeration. The aggregate particles can be made to be quite small, but even then will be far larger than the encapsulated PCM particles contained within them. The cement in the aggregate will further protect the PCM contained within the acrylic capsules. It will also present an ideal and easily handled material that will form a strong bond with any cementitious end product.

The present invention provides a cementitious composition using specially selected materials that will bind with the fluid media of the slurry or cake and enrobe the encapsulated PCM solids within the cementitious viscous mass formed thereby. The cementitious materials are selected based on the qualities which are desired in the aggregate or extrudite being made for the end user. The aggregate mix design is optimized to achieve the desired result when used in conjunction with these other cements or products of the end user.

The aggregate is an agglomeration that can be made in any size, from fine sand to coarse gravel depending on the needs of the final product. ASTM C 125-07 fineness modulus principles are used to size phase change aggregate screen sizes to minimize cement binder and maximize phase change aggregate to achieve maximum enthalpy in the final product

Many substances, either by themselves or in combination, are capable of absorbing or adsorbing or becoming hydrated by the fluids of a encapsulated PCM slurry.

The process of combining or blending the slurry with such substances results in the production of an array of solid materials that can be made into aggregates for use in a variety of applications. These substances include, for example, powders with pozzolanic qualities, inorganic salts, fly ash, hydrous silicates, super kaolins, Portland Cement, magnesia cements, metal oxide cements, phosphate cements, silicates, and a variety of other acid-base cements.

In the mixing process the encapsulated PCM solids contained in the slurry are further incorporated within the aggregate or extrudite. The result of the process is that aggregates or extrudite made with encapsulated PCM slurry will be inert for purposes of mixing with other materials, but will be far easier and safer to handle and will have fire resistant qualities that are lacking in most dry encapsulated PCM.

Through selection of the amounts and types of substances used in these processes, the encapsulated PCM aggregate can be tailored for qualities such as hardness, ability to bond with other materials, and the amounts and multiple types of encapsulated PCM contained in it.

Further, if in an aggregate form, the PCM viscous mass can be processed so that size and particle distribution of the aggregate may be optimized for a particular application or for more generally applicability.

U.S. Pat. No. 4,747,240 speaks to the utility of using encapsulated PCM in an aggregate in the manufacture of interior building materials. The encapsulated PCM employed in that invention was encapsulated PCM in its dry form. The difficulties encountered when using encapsulated PCM in slurry form were not addressed, and no disclosure was made therein relating to the manufacture or use of encapsulated PCM aggregate from slurry or cake. Likewise, no disclosure was made for making or using an aggregate of such composition that has fire resistant qualities, and of a size that avoids the need for hazard precautions.

Therefore, it is also an aspect of this invention to incorporate dry encapsulated PCM with water and a combination of the substances described above, in connection with PCM slurry, to make an aggregate with fire resistant qualities, and without hazards associated with the handling of the material.

It is an aspect of the present invention to combine encapsulated PCM in the form of slurry or cake with other materials that can be hydrated or that can absorb or adsorb the water and other fluids contained therein. A partial listing of these materials is shown above. This will result in significant savings to encapsulated PCM manufacturers who would otherwise be compelled to remove the fluids from the slurry or cake by spray drying or by other costly means. It will also result in further enrobing of the encapsulated PCM solids within the materials formed in the process. In the process, the slurry or cake PCM becomes an integral part of a dry, solid aggregate with fire resistant qualities that may safely be handled without special hazard precautions or training required of the user. The resulting aggregate can be incorporated directly into a wide variety of cementitious materials of the end user and other end products.

It is a further aspect of this invention to tailor the dry solids resulting from the above described processes in terms of size, particle size distribution, compatibility with other materials, fire resistance, percentage of encapsulated PCM solids contained therein, suitability for any particular kind of cement system that may be employed therewith (e.g., Portland based, MagPhosphate based, MagOxychloride based,) or to any particular application wherein phase change qualities are imparted to a cementitious product by use of the aggregate.

The essence of certain embodiments of the invention is that PCM can be incorporated within an aggregate or extrudite which is then easily handled and which can then be incorporated into many final products without any radical modifications of existing production procedures.

The aggregates produced by this invention can easily incorporate PCM into a wide range of building materials. It is therefore also an aspect of this invention that building materials, such as wall board, plaster, render, tiles, ceiling panels, floors, and floor underlayment, and any other building materials manufactured by any cementitious process be capable of adding phase change qualities by simply including the aggregate with the other feedstocks in the production processes used to produce those products.

In embodiments of the present invention, the drying process for separating the encapsulated PCM form the encapsulation slurry is replaced by mixing feedstocks in a process wherein the slurry itself is used to make an aggregate with fire resistant qualities that can then be directly incorporated, as an aggregate, into the concrete mix of a wide variety of cementitious end products or as an extrudite in a variety of end products.

The present invention provides for the incorporation of encapsulated PCM particles, in the form of dry powder, wet or damp cake, or contained within an emulsion, into an aggregate in order to impart fire resistant qualities to the PCM.

The use of aggregate as the means by which PCM is incorporated into cementitious end products has many advantages. As noted, the cost of drying the mPCM slurry can be saved. Fire resistant qualities can be imparted to the PCM particles. Particles of PCM aggregate are easier and safer to handle than PCM powder. PCM aggregate can be custom manufactured so that it may be incorporated into building materials with little or no alteration required of the manufacturing processes of those building materials.

An embodiment of the present invention also relates to the manufacture of PCM aggregates through a process of mixing the PCM particles with other materials, agglomerating the resulting mixture into larger, agglomerated particles, curing the agglomerated particles, and classifying them for incorporation into the concrete mix of cementitious end products.

The prior art known to applicants does not teach a process that provides the economic benefits and convenience provided by this invention, which includes an innovative step where PCM particles, and in particular, the encapsulated PCM slurries, are made part of a manufactured aggregate according to specifications required by the end product, including those pertaining to fire resistance.

Unlike the present invention, U.S. Pat. No. 4,747,240 does not contemplate the manufacture of an aggregate from PCM, the manufacture of an extrudite from PCM, the use of encapsulated PCM liquid emulsions in a system that bypasses the spray drying process to make an aggregate, nor does it seek to mitigate the high degree of flammability that is characteristic of PCM.

Turning now to the drawings, FIG. 1 presents a process for the production of a fire resistant PCM viscous mass (90) which can be fashioned into numerous forms such as an aggregate, multiple extruded shapes, or self bonded directly to material such as insulation foam board. The flexibility in forms of output using the novel formulation of this invention is complemented by the range of options for most ingredients or feedstocks. The foundation of this novel formulation is an encapsulated PCM which can be any form of encapsulated PCMs. Currently encapsulated PCMs are available in a wet PCM (60) form such as BASF/Ciba's PC200, or a dry PCM (70) which is a wet PCM (60) dried in an expensive drying process or a cake PCM (80) such as offered by Microtek Laboratories which generally have about a 30% moisture content. Wet PCM (60) generally has a moisture content of between 40% and 60%. BASF/Ciba's PC200® generally has a moisture content of approximately 51%. Dry PCM (70) generally has a moisture content of 5% or less and is produced from a wet PCM (60) which has been dried in an expensive step that is generally an unnecessary step for use in this invention. Cake PCM (80), currently manufactured by Microtek Laboratories, has gone through an extra step in the production process to remove most residual liquid remaining from the encapsulation process.

Besides the three forms of encapsulated PCMs noted above, encapsulated PCMs are available in a wide range of shell sizes from <5μ to about ¼ inch, and a wide range of targeted melting temperatures, generally ranging from −57° C. to 52° C. (−76° F. to 125° F.). The process for production of the materials disclosed herein accommodates all of these variations in forms of PCMs and moisture content without compromising optimum performance in an end use product. For a specific batch of PCM viscous mass (90) either one or a combination of encapsulated PCMs (60), (70), and (80) are metered and pumped (62) or (72) or (82) into tank (12). In tank (12) water (50) is added as necessary to achieve the desired moisture content of the resulting PCM aqueous suspension (11). The PCM aqueous suspension (11) in tank (12) may need a surfactant (54) metered and piped (56) into the mix in order to aid in the blending of dry PCM (70) or cake PCM (80). The PCM aqueous suspension (11) is then metered and pumped (14) into a mixer (88) where it is aggressively mixed with the already blended dry feedstock (15). The dry feedstock (15) comprises a cementitious binder (30) and an adsorbent and/or absorbent such as a clay mineral (32). Other optional feedstocks (34) may include fire retardants or fillers, and in some cases to achieve greater flexibility and strength of an embodiment, fibrous reinforcing materials such as chopped or milled fibers (43) may be added to the dry mix. The desired amounts of dry feedstocks (15), which may or may not include material from feedstocks (34) and (43), are metered and augered (31), (33), (35) and (45) to a ribbon blender (44) for blending. Blended dry feedstock (15) is augered to a dry storage bin (16).

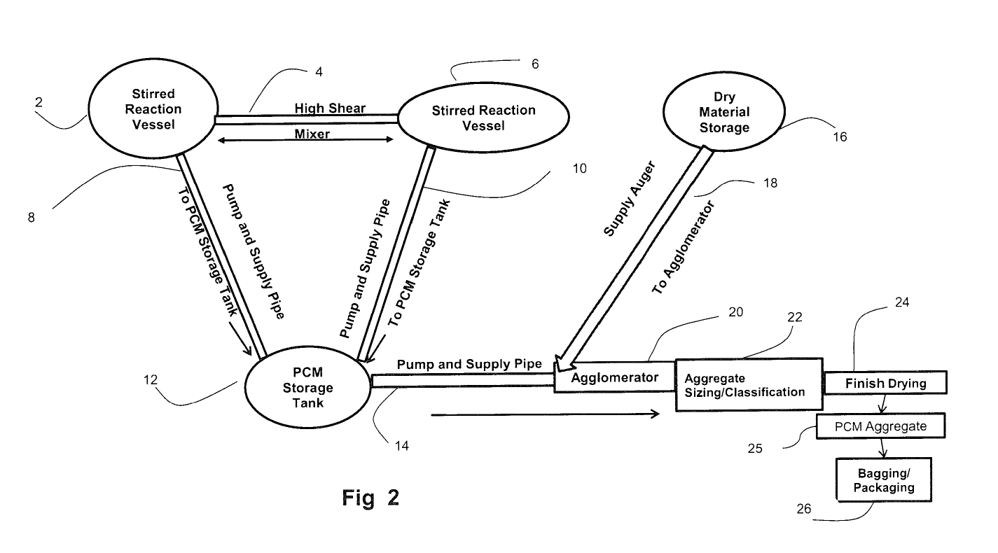

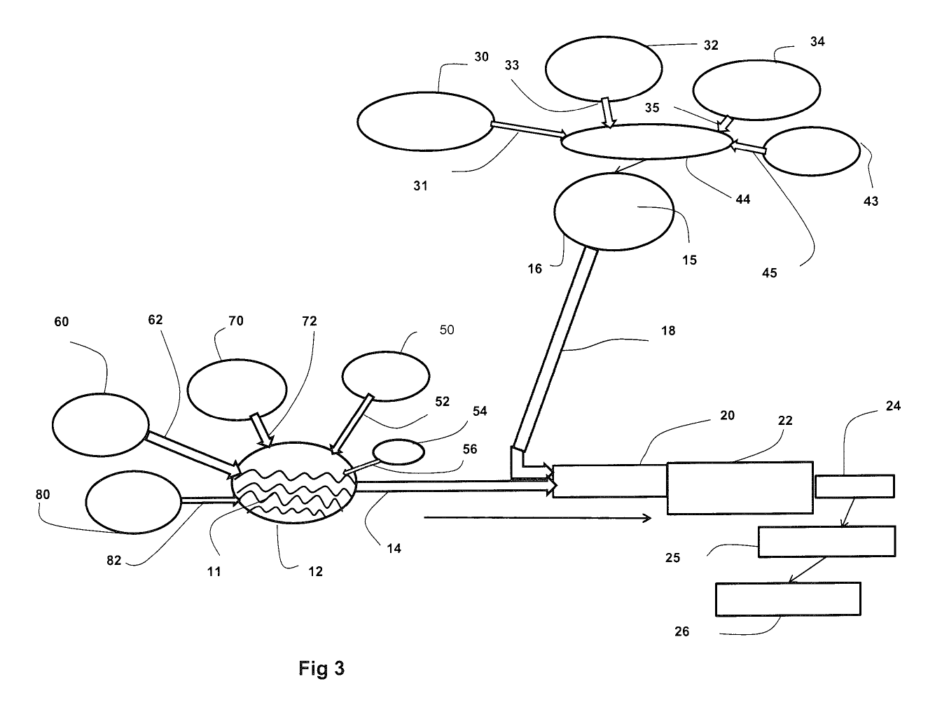

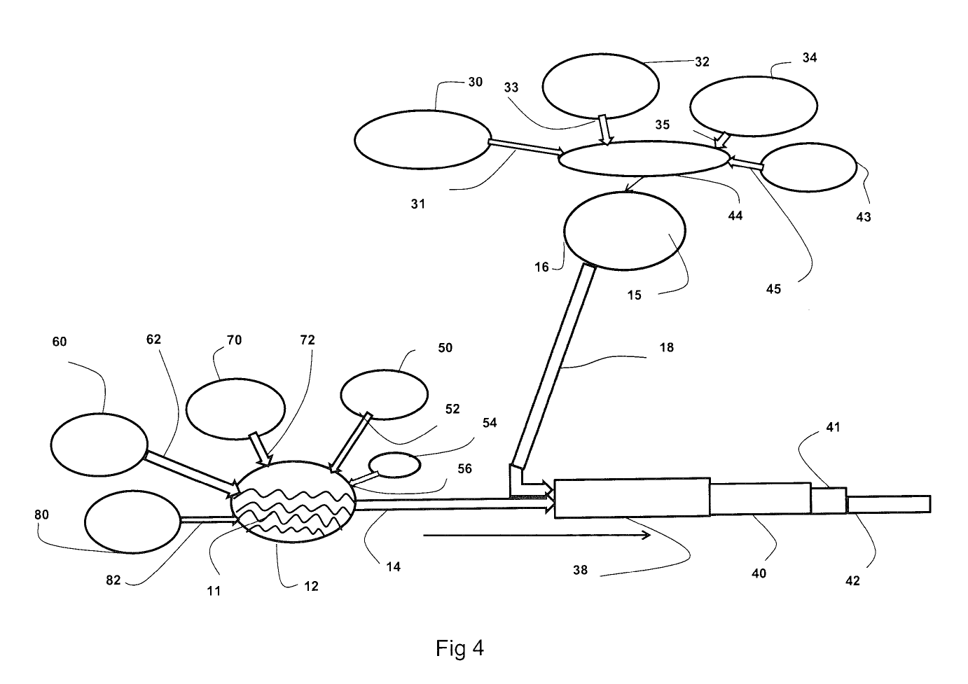

The cementitious binder (30) may be a hydraulic cement, a silicate cement, or an acid-base cement, i. e., any combination of inorganic materials capable of acting as a bonding agent to bind other materials together into a hardened mass (e.g. Portland Cements, plaster of Paris, silicate cements, magnesium phosphate cements, magnesium oxychloride cements, magnesium oxysulfate cements, etc.). A preferred cementitious binder (30) for the PCM viscous mass (90) or embodiments of this PCM viscous mass (90), presented in FIG. 2 and FIG. 3 as a PCM aggregate (25) or in FIG. 4 as a PCM extruded viscous mass (41), is an acid-base cement such as a magnesium phosphate cement. A particular type of acid-base cement is a combination of magnesium oxide and monopotassium phosphate, referred to by Wagh as magnesium potassium phosphate ceramic. Monopotassium phosphate, also known as potassium acid phosphate (MKP), has the formula KH₂PO₄.

Acid-base cements are defined on page 3 of Wagh's book, cited below, and discussed in Chapter 1. In an acid-base cement, the PCM particles will be contained within matrices of the three dimensional amorphous clusters formed by the cement and other materials forming the PCM viscous mass (90). The particle clusters can be made to be quite small, but even then will be far larger than the PCM particles contained within the PCM aqueous suspension (11). The cement in the clusters will further protect the PCM contained within its shell, thus significantly protecting the shell, which previous methods could only accomplish by varying the composition of the shell material. Some shell materials impact the efficiency of the PCM within the shell. The PCM aggregates disclosed herein also provide an ideal and easily handled material.

A preferred combination of ingredients for PCM viscous mass (90) and most embodiments comprises a preferred cementitious binder (30) of about 3 parts dead burnt magnesium oxide and 6 parts monopotassium phosphate, 20 parts palygorskite or modified attapulgite clays (32) and about 72 parts encapsulated PCM aqueous suspension (11). The compostion of the PCM aqueous suspension (11) for the wet PCM (60) is generally between 40% and 60% encapsulated PCM and 40% and 60% residual liquid.

Companies involved in the industrial extraction and processing of gellant grade attapulgite clay include Active Minerals International LLC and BASF Corporation. Active Minerals produces a patented, purified form of attapulgite known as Actigel® 208 in which the clay has been chemically and mechanically exfoliated into discrete pseudo nanoparticles of attapulgite which are about 2 microns in length and 30 Angstroms in diameter. Most non-attapulgite particles are removed, leaving a purified form of attapulgite.

Based on research conducted at the Argonne National Laboratory as noted in Wagh's book CHEMICALLY BONDED PHOSPHATE CERAMICS (ELSEVIER 2004) at pages 239-241, acid-base cements such as the cementitious binder (30) above can convert flammable materials into nonflammable forms, substantially eliminating the risk of flammability associated with existing preparations. The novel formulations disclosed herein convert highly flammable hydrocarbon PCMs into a nonflammable PCM viscous mass (90). The nonflammable properties of the PCM viscous mass (90) are enhanced by the addition of the attapulgite clays.

An advantage of using a preferred acid-base cement as the cementitious binder (30) is the elimination of any problems with containment of the PCM. The cementitious mixture encases or enrobes the PCM in a non-leaching material, even when a cured embodiment of the PCM viscous mass (90), such as a PCM aggregate (25) of FIG. 3, is ground into very fine particle sizes.

The preferred cementitious binder (30) also presents an ideal and easily handled aggregate material. The preferred novel formulations in aggregate form presents a safe and easily handled fire resistant PCM aggregate for use in various end products. U.S. Pat. No. 7,166,355, issued Jan. 23, 2007 for Use of Microcapsules in Gypsum Plaster board to Jahns et al. discusses a process wherein microencapsulated PCM is incorporated directly into cementitious building materials, i.e., wallboard core and plasterboard. In this patent, special steps must be taken to insure the bonding of all components because of the poor bonding nature of the microencapsulated PCM particles. Commercially available dry PCM (70) when incorporated in cementitious building materials has many drawbacks. The microscopic particle size increases water demand beyond typical water/cement ratios and special precautions must be taken to avoid inhaling the particles. U.S. Pat. No. 6,099,894 mentions these precautions and addresses special precautions take to avoid inhaling respirable sub 10 micron PCM particles. The novel formulations of fire resistant PCM aggregates (25) disclosed herein preferably have a non respirable minimum size of 20 microns.

Cement binders may hydrate from 10% to 60% of their weight of water. Clay minerals (32) may adsorb or absorb from about one to four times their weight of water. When an aqueous suspension of encapsulated PCM with a viscosity of 200 mPa.s is combined with cement binder (30), clay minerals (32) and optional feedstocks (34) and (43) are subjected to vigorous mixing (38), the combined ingredients of this novel formulation begin physical and chemical reactions which cause them to coalesce very quickly into a PCM viscous mass (90). At this point in the chemical curing process, viscous mass (90) may be described as a non Newtonian semi solid that can hold peaks and has the consistency of peanut butter or shortening. The viscous mass (90) while in this plastic state in the curing cycle moves through an extruder (40) which shapes the PCM viscous mass (90) into extruded form (41) prior to setting and hardening on the final PCM product (42). The objective is to combine and mix the materials, including sufficient moisture to provide a viscous mass with sufficient plasticity to permit it to be processed in an extrusion process.

FIG. 2 illustrates a process for manufacturing PCM aggregate (25) (in FIG. 3) integrated with the manufacture of encapsulated PCM using processes such as that of BASF/Ciba: “Particulate Compositions and Their Manufacture,” disclosed in U.S. Published Patent App. 2007/0224899. Generally, in BASF/Ciba's process, a PCM aqueous suspension (11) is formed containing a PCM in liquid or solid form, capsule material, nucleating agents, wetting agents, and surfactants. These ingredients are mixed in stirred reaction vessels (2) and (6) connected by a high shear mixer (4). The high shear mixer (4) causes the blended or mixed ingredients to flow between stirred reaction vessels (2) and (6) to optimize the aqueous suspension of the encapsulated material. The PCM emulsion is pumped back and forth between vessels (2) and (6) until the desired PCM capsule size is achieved (generally from 1 to 10 microns), encapsulating the PCM in a bubble-like polymer shell and forming an PCM aqueous suspension (11) (FIG. 1) containing approximately 35% to 60% encapsulated PCM suspended in a residual liquid which contains water, non-encapsulated PCM and other ingredients not fully utilized in the encapsulation process. The PCM aqueous suspension (11) (FIG. 1) formed by BASF/Ciba's encapsulation process is pumped into the PCM storage tank (12). In the BASF/Ciba process to produce encapsulated PCM, the residual liquid in the suspension is approximately 55% of the total weight and the PCM capsules are the remaining approximately 45%. The PCM aqueous suspension (11) (FIG. 1) in storage tank (12) is metered and pumped (14) to an agglomerator (20) where it is aggressively mixed with the already blended dry feedstocks (15) in dry material storage (16) which has been metered by weight and augured (18) into the agglomerator (20).

Components of the dry materials (15), not shown in FIG. 2, are more fully illustrated in FIG. 1 as a cementitious binder (30), a clay mineral (32), optional feedstocks (34) and chopped or milled fibers (43). As described in FIG. 1, the cementitious binder (30) may be any combination of inorganic materials capable of acting as a bonding agent to bind other materials together into a hardened mass, as discussed above.

The dry material feedstocks (15) and the PCM aqueous suspension (11) are vigorously mixed in the agglomerator (20) to form the PCM aggregate (25) (FIG. 3). The PCM aggregate (25) (FIG. 3) particle size can vary in size from about 0.35 mm (0.0140 inch) to about 19 mm (¾ inch). After the PCM aggregate is formed in the agglomerator (20), it is sized and classified (22) before proceeding to a final drying process (24). The various sizes of aggregate size may be combined to conform to Fineness Modulus Specifications and particle packing formulae to conform to the end-user's specifications. Smaller PCM aggregates (0.35 mm to 2 mm) can be incorporated into a wide range of insulation materials.

Extensive testing on a flammable form of PCM in insulation has been conducted at Oak Ridge Laboratories. The PCM used in these tests has thus far been flammable encapsulated PCM or encapsulated PCM treated with fire retardant. The compositions disclosed herein are nonflammable and require no additional fire retardant treatment. Blown in insulation materials such as cellulose, rock wool and fiberglass with encapsulated PCMs incorporated can benefit from the increased thermal mass and have been proven to decrease energy use and shift peak power demands. Smaller PCM aggregates (25) can be incorporated in batt insulation and foam insulation boards made of polyisocyanurate, expanded polystyrene, urethane and beadboard. Larger PCM aggregates (25) (4 to 19 mm) may be added to poured concrete, precast concrete and concrete masonry units (CMUs).

The final step in the PCM aggregate (25) process is some form of bagging or other type of packaging (26) for shipping.

FIG. 3 is a flow chart of the process to produce PCM aggregate (25), an embodiment employing a novel formula for a fire resistant PCM viscous mass (90), as in FIG. 1. FIG. 3 is more detailed in steps to make the PCM aggregate than FIG. 2 and it does not present the manufacture of encapsulated PCM found in vessels or components (2), (4), (6), (8), or (10) of FIG. 2. FIG. 3 begins with the options available for encapsulated PCM—wet PCM (60), dry PCM (70), and cake PCM (80). These categories of encapsulated PCMs are based generally on the moisture content of commercially available encapsulated PCMs. For example, BASF/Ciba's PC200 is a wet PCM with a moisture content of approximately 55% where the encapsulated PCM is in suspension in the residual liquids from the encapsulation manufacturing process. This residual liquid contains water, non-encapsulated PCM and other ingredients not fully utilized in the encapsulation process. There are reported examples where these residual liquids caused bonding problems when the encapsulated PCMs were applied in either wet (60), dry (70), or cake (80) form because the non-water residuals, either suspended in the liquid and/or adhered to the shell, created incompatibility problems with other ingredients in end products. The acid-base cements preferred in the present embodiments mechanically and/or chemically bond these residues, along with the encapsulated PCM, into the PCM viscous mass (90) without impact based on a particular embodiment such as PCM aggregate (25) or PCM compositions extruded as a viscous mass (41). Optional feedstocks (34) or chopped or milled fibers (43) are also physically and/or chemically bonded by the acid-base cement (30).

Encapsulated PCM, either wet (60), dry (70), or cake (80) or a combination of these, are metered (62), (72), and (82) into a tank (12) where additional water (50), if needed, is metered in (52). Wet PCM (60) may require no additional water (50) whereas cake PCM (80) and dry PCM (70) will require additional water (50). The PCM aqueous suspension (11) in tank (12) may need a surfactant (54) metered and piped (56) into the mix in order to aid in the blending of dry PCM (70) or cake PCM (80). At this stage, the liquid in tank (12) is a PCM aqueous suspension (11) and ready to be pumped (14) into an agglomerator (20) for vigorous mixing and agglomeration with the blended dry materials (15). The blended dry materials (30), (32), (34), and (43) in this embodiment are fully described above. Also fully described is the process of agglomerating (20) the dry materials (15) with the PCM aqueous suspension to form the PCM aggregate (25) which goes through a sizing process (22) and final drying (24) before bagging and packaging (26) for shipment.

PCM aggregate (25) substantially mitigates the risk associated with flammability, as well as ease of application, compatibility with existing ingredients in products and health hazards associated with the breathing and handling of dry PCM (70). PCM aggregate (25) can be produced in a wide range of sizes, or using multiple melting temperature PCMs, and the acid-base cement (30) protects the PCM shell without increasing interference with the thermal properties of encapsulated PCM.

FIG. 4 is a flow chart of a process to produce a fire resistant PCM extruded viscous mass (41) which will self bond to most materials, thus increasing the thermal mass. In FIG. 4, the process of making the PCM aqueous suspension (11) and the blended dry materials (15) are essentially identical to those in the description above in relation to FIG. 2 and FIG. 3. While in FIG. 2 and FIG. 3, these feedstocks for the novel formulations of the invention are mixed in an agglomerator (20). In this embodiment, these same ingredients are vigorously mixed in mixer (38) to produce a PCM viscous mass (90) which is immediately conveyed to an extruder (40) with a mold head such as a sheet mold head. For example, a sheet or layer (42) of the PCM extruded viscous mass (41) from 4 to 15 mm thick can be applied to, and will self bond when cured, to a wide range of board products. The PCM extruded viscous mass (41) will act both as a fire barrier and add thermal storage capacity to plywood, oriented strand board (OSB), drywall boards, cement board and both foil faced and un-faced insulation boards. Present materials and methods do not provide the fire barrier, or the non-flammability, or the flexibility of application that this embodiment offers.

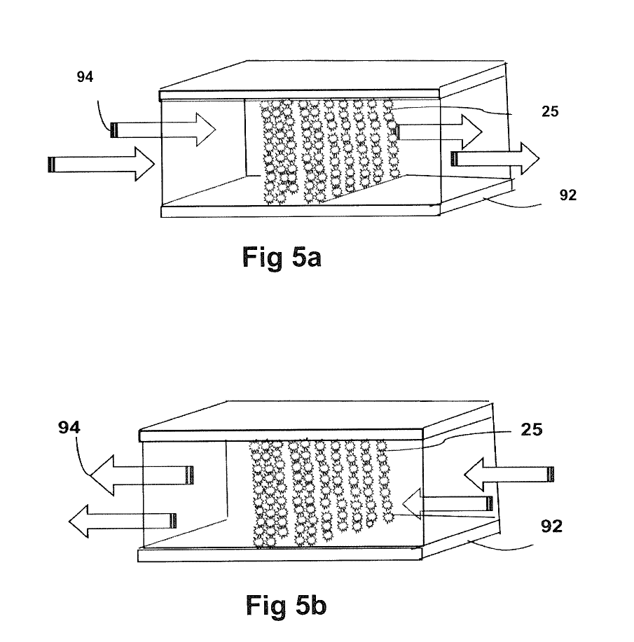

Presented in FIG. 5a and FIG. 5b is an embodiment of PCM aggregate (25) in an application as a heat exchanger/heat storage medium. PCM Thermal Solutions, Inc. of Naperville, Ill. in cooperation with MJM Engineering Co., offers to design and develop customized heat exchangers that incorporate PCM materials. The companies presently use either plastic packaged PCM's or metal-encapsulated PCM's. Unlike the aggregate embodiments disclosed herein, their products rely on containment in plastic or metal containers to prevent leakage of the PCM salts. FIG. 5a illustrates how fire resistant PCM aggregate (25), sized and graded to optimize surface area and efficient air or fluid flow, or an extruded fire resistant PCM viscous mass (41) (not illustrated here) shaped to optimize surface area and efficient air flow (94) can be employed to capture and store thermal energy (heat). This stored energy may be used to heat or cool depending on the needed application and will serve to reduce overall energy use and shift peak demand. PCM aggregate (25) or a column of PCM extruded viscous mass (41) (not illustrated) could be installed in a duct (92) or other enclosed space where hot or cold air (94) is flowing over the PCM aggregate (25), charging the PCM aggregate (25) with stored heat. FIG. 5a and FIG. 5b suggest an enclosed duct but, unlike existing systems, PCM aggregate (25) could easily be installed in any space where air flows freely such as under a raised computer floor or on ceiling tiles.

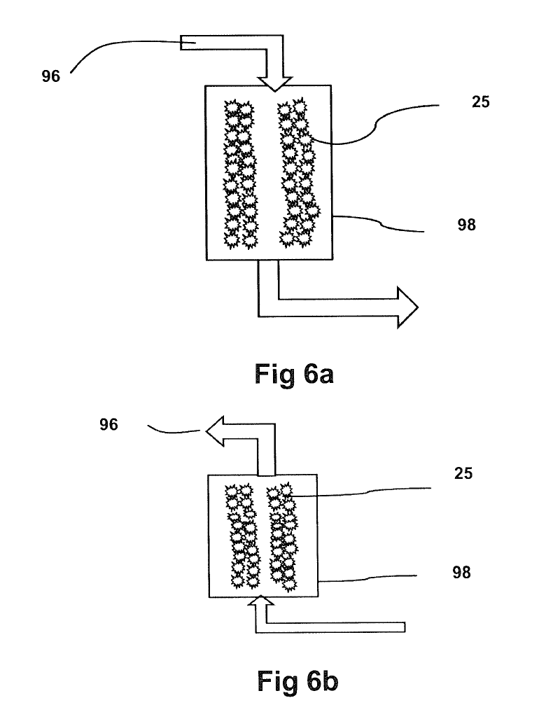

FIG. 6a and FIG. 6b illustrate an embodiment where PCM aggregate (25) or PCM extruded mass (41) in a cylindrical column (not illustrated, but can have any suitable cross section)) function in a fluid or gas flow (96) within a closed system, in this example illustrated by a tank (98). The PCM aggregate (25) functions to store heat and release heat in the same functional way as described above for FIG. 5a and FIG. 5b. The difference is that the heat is stored or released back into a liquid or gas flowing over the PCM aggregate within a closed system. Unlike existing systems, the PCM aggregate (25) or PCM extruded mass (41) in any desired shape does not have to be contained beyond the form that the invention can create because there is no leakage of the PCM aggregate (25) material into the liquid or gas. The apparatus and process described secures the PCM so that it will not react or release into the heat carrying liquid or gas.

### EXAMPLES

The invention is further illustrated by the following non-limiting examples.

### Example 1

A phase change aggregate with an enthalpy of 31 J/g and a mean particle size of ⅛ inch was produced in a rotating drum agglomerator in a continuous production process. An acid/base dry feed cement containing 11% magnesium oxide, 27% monopotassium phosphate, 5% wollastonite, 44% class C fly ash, plus 11% magnesium aluminum silicate was introduced into the rotating agglomerator at a rate of 6.52 pounds per minute. A like amount of Ciba Chemicals [now BASF/Ciba] DPNT0031 microencapsulated PCM (mPCM) liquid emulsion was pumped to a fine spray nozzle inside the drum agglomerator. With a residence time of 3.1 minutes inside the rotating drum agglomerator, a phase change aggregate with mean average diameter of ⅛ inch and an aggregate outflow rate of 0.3 cubic feet per minute was produced in a continuous test production process.

### Example 2

A binder was prepared using dead burned magnesium oxide (HR98 from Martin Marietta), finely ground monopotassium phosphate (300 mesh) and class C fly ash in a ratio of 1:3:7. 100 grams of MgO, 300 grams of MKP, and 700 grams of fly ash were combined as dry ingredients. This mixture was added to 2400 gram of mPCM liquid emulsion (Ciba Chemicals [now BASF/Ciba] DPNT0031). When mixed, the sample began to gel and harden within 30 seconds. After 1 hour the sample was broken into particles of 1/2 inch diameter or less with a high speed shear mixer. The dry particles, now usable as an aggregate in concrete mixes, were tested to contain 35% PCM solids with an enthalpy of 47 J/g.

### Example 3

100 grams of mPCM liquid emulsion (Ciba Chemicals [now BASF/Ciba] DPNT0031) was mixed with 100 grams of magnesium aluminum silicate powder (Acti-Gel (R) 208). Within 15 seconds, all of the fluid of the mPCM emulsion was adsorbed, leaving a sandlike substance. Flame from a propane torch was applied directly to the sandlike substance, both immediately after mixing, and after it had been allowed to dry for 24 hours, and in both instances, the substance could not be ignited, although it contained thirty percent mPCM with a measured enthalpy of 34 J/g.

### Example 4

An aggregate was prepared by mixing 100 grams diatomaceous earth, 100 grams hydrous sodium silicate (type G from PQ Corp.), 100 grams of dead burned magnesium oxide (HR98 from Martin Marietta) with 1000 grams of mPCM liquid emulsion (Ciba Chemicals [now BASF/Ciba] DPNT0031). This mixture was allowed to cure and dry, resulting in a hardened, solid mass. The mass was then sized by placing it in a blender, resulting in an aggregate ranging from fine sand to ¼ inch gravel in size. The entire dried sample, weighing 1040 grams, was then mixed together with a binder consisting of 400 grams of light burned magnesium oxide (Oxymag® from Premier Chemicals), 300 grams of liquid magnesium chloride (35 baume from Cargill), and filler comprised of 467 grams of wet sawdust. During mixing, 180 grams of water was added, as well as 34 grams of a defoamer, Burst 5470®. The resulting mix was placed in a mold to produce a 26 cm×31 cm size wallboard, 15 mm thick. The average enthalpy was 23.5 J/g, density was 1.35 g/cm3 and board area enthalpy was 540 KJ/m3.

### Example 5

An mPCM liquid emulsion (Ciba Chemicals [now BASF/Ciba] DPNT0031) was added to a like weight of a mix of the following dry materials: fly ash (ranging from 30% to 70% by weight of the dry mix), magnesium oxide (ranging from 10% to 50%) monopotassium phosphate (MKP) (ranging from 20% to 60%), plus aluminum silicates (ranging from 5% to 25%). The mPCM liquid emulsion (Ciba Chemicals [now BASF/Ciba] DPNT0031) and the dry mix were thoroughly blended together and allowed to harden and dry. When semi-solid, the mix was broken up by any conventional means, such as grinding. When fully cured and dried, the material size was further reduced by conventional methods in order to achieve a desired particle size. When the mPCM liquid emulsion (Ciba Chemicals [now BASF/Ciba] DPNT0031) contained 45% mPCM solids, the resulting mixture contained 22.5% mPCM solids on a wet basis. When fully cured, the amount of mPCM solids in the resulting dry aggregate was about 6 percent higher.

### Example 6

In another example, the dry mix was comprised of lightly calcined magnesium oxide (10% to 40%), dolomite powder (CaMg(CO₃)₂) (10% to 40%), magnesium chloride hexahydrate (10% to 40%), antimony pentoxide (5% to 20%) as a fire retardant and diatomaceous earth (20% to 50%). To this dry mixture, mPCM liquid emulsion (Ciba Chemicals [now BASF/Ciba] DPNT0031) was added in a ratio of one part of dry mix to two parts slurry. These ingredients were thoroughly mixed and allowed to harden and dry. The slurry contained 45% of mPCM solids, the resulting mixture had about 37% solids on a wet basis. The percentage of mPCM solids in the dry, fully cured aggregate was higher.

### Example 7

A fire resistant board with an estimated B—fire rating was made as follows. Dry ingredients including 435 grams magnesium oxide (Martin Marietta HR 98), 425 grams monopotassium phosphate (300 mesh), 250 grams wollastonite, plus 250 grams class C fly ash produced a magnesium phosphate cementitious material. This was mixed with wet ingredients: 15 grams super plasticizer [Rheobuild 1000®], 500 grams dry mPCM (Ciba Chemicals [now BASF/Ciba] DPNT-0176) and 820 grams of water. The dry ingredients were mixed thoroughly with the wet and placed in a 26 cm×31 cm×1.27 cm mold. A layer of 2.5 oz. nonwoven veil fiberglass fabric was placed on both sides. The board hardened and was de-molded in 8 hours. A Perkin Elmer Pyrus DSC 1 Differential Scanning Calorimeter was used to test board enthalpy. The tested board enthalpy level was 29.7 J/g (427 KJ/m2), with a density of 1.15 g/cm³. A propane torch was positioned 7 cm from the board face. The torch flame was directed at the center of the board and held in place for 10 seconds, and the flame extinguished when the torch was removed. The torch was applied a second time for 30 seconds when the torch was removed the flame again extinguished.

### Example 8

A phase change aggregate as described above in Example 8 with an average diameter of ¼ inch was placed in a rectangular enclosure measuring 3 inches by 3 inches by 12 inches high with a volume of 108 cubic inches. Tests revealed 32 percent void space between the phase change aggregate particles for air or fluid to flow through. A total of 1.84 pounds of phase change aggregate with an enthalpy of 34 J/g was placed in the enclosure. A volume of 2 cfm, 50 degree Fahrenheit air was introduced at the bottom for 8 hours to simulate night time air conditions. Tests revealed significant potential for use of the phase change aggregate as a heat exchange medium to capture cool night time air for day time cooling

### Example 9

A fire resistant PCM extrudite was formed of these materials by weight: 10 parts dead burned magnesium oxide, 20 parts monopotassium phosphate (MKP) (300 mesh), 80 parts purified attapulgite clay, 300 parts microencapsulated PCM liquid emulsion (Ciba Chemicals [now BASF/Ciba] DPNT0031), and one half part micro polypropylene fibers. The ingredients of the formula were mixed with a shear mixer and in about 20 seconds formed a thick viscous mass. A one quarter inch thick layer of the PCM viscous mass was extruded onto the surfaces of a foil faced polyisocyanurate insulation board and an expanded polystyrene foam board. The fire resistant PCM extrudite was effective in adding thermal mass to the light weight insulation boards and imparting fire resistance to otherwise flammable products.

### Example 10

A fine, sandlike PCM aggregate with a mean diameter of about 1/32 inch or about 170 mesh was prepared for testing in blown in insulation. The PCM aggregate was intended to increase the thermal mass of the insulation and moderate daytime to night time temperature fluctuations and thus to decrease peak power demands. A PCM aggregate was prepared with 10 parts 300 mesh Martin Marietta P98 PV magnesium oxide (MgO), 20 parts 200 mesh Peak monopotassium phosphate (MKP) and 80 parts Actigel® 208, a purified attapulgite clay. The three components of the dry mix were blended and then added to 300 parts of BASF/Ciba PCM PC200 aqueous liquid emulsion. The original intention for the inclusion of the purified attapulgite was to soak up, adsorb or absorb the excess water and the wax and acrylic polymer residues not bound up in the manufacturer's PCM encapsulation process. The dry ingredients were added to the PCM liquid emulsion and mixed with a shear mixer. Within a few seconds, the mixture formed a viscous mass. Shear mixing continued for five minutes and the mass broke down into ¼ to ¾ inch PCM aggregate particles.

The resulting PCM aggregate was air dried at room temperature for twelve hours and then processed in a ball mill for further size reduction to sizes ranging from 80 to 140 mesh. PCM aggregate particles smaller than 140 mesh were removed by sieves. An unexpected discovery was made when the sub-140 mesh PCM aggregate, ranging in size from about 150 to about 300 mesh, was exposed to direct flame from a propane torch and could not be ignited. When further examined, an additional surprising discovery was made. The sub-200 mesh particles of the cementitious binder combined with the pseudo/nano particle size of the purified attapulgite clay (which contains high aspect ratio rodlike particles about 20 microns long by about 30 Angstroms in diameter) formed a hard, fire resistant mass around the 2 to 15 micron size acrylic shells of the microencapsulated PCM. The hard, fire resistant mass surrounding the acrylic shells should allow manufacturers to use aggressive mixing devices to blend such aggregates with other materials without concern for damaging the acrylic shells. Analysis by Differential Scanning Calorimeter showed the enthalpy of the samples to range from about 70 to about 80 J/g.

Based upon the above examples, the proportions shown in the Table below are considered appropriate for PCM compositions based upon aqueous suspensions or slurries of encapsulated PCM. All percentages are by weight.

| | | | | | Possible Ranges Low to |
|---|---|---|---|---|---|
| Composition | Examples of Alternative | | | | High of Ingredients in |
| Examples 9 and 10 | Composition | | | | Composition |
| Cementitious Binder | 30 | 7.3% | 30 | 4.9 | 4% to 8% |
| Adsorbent or Absorbent | 80 | 19.5% | 80 | 13.1% | 8% to 30% |
| PCM Solids | 135 | 32.9 | 225 | 36.9% | 32% to 40% |
| Aqueous Liquid | 165 | 40.2% | 375 | 45.1% | 30% to 60% |
| Total | 410 | 100.0% | 610 | 100.0% | |

Although only exemplary embodiments of the invention have been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

Although the present invention has been described with reference to preferred embodiments, numerous modifications and variations can be made and still the result will come within the scope of the invention. No limitation with respect to the specific embodiments disclosed herein is intended or should be inferred. Each process embodiment described herein has numerous equivalents.

We claim:

1. A method of producing a fire resistant phase change material (PCM), comprising steps of:
providing at least one PCM in encapsulated form; and
combining the encapsulated PCM with a cementitious binder and an absorbent and/or adsorbent material.

2. The method of claim 1, further comprising the addition of sufficient aqueous liquid to produce a viscous mass when the ingredients of claim 1 are mixed with said liquid to form a fire resistant PCM composition.

3. The method of claim 2 wherein the final moisture content of said composition is in the range of from about 30 to about 60 weight percent.

4. The method of claim 1 wherein the ingredients are present in the following proportions as weight percent of the total:
PCM solids: from about 25 to about 90
cementitious binder: from about 0.25 to about 20
absorbent and/or adsorbent: from about 5 to about 50.

5. The method of claim 4 wherein said absorbent and/or adsorbent is present as from about one to about six times the weight percent of said cementitious binder.

6. The method of claim 1 wherein the encapsulated PCM is provided in an aqueous slurry, suspension or emulsion.

7. The method of claim 6 wherein the aqueous PCM slurry, suspension or emulsion comprises from about 20 to about 70 weight percent liquid.

8. The method of claim 1 wherein the encapsulated PCM is provided in a damp cake form.

9. The method of claim 1 wherein the encapsulated PCM is provided as a substantially dry powder.

10. The method of claim 1 wherein said PCM is a microencapsulated PCM (mPCM).

11. The method of claim 1, 6 or 10 wherein said PCM is encapsulated in polymeric shells.

12. The method of claim 11 wherein said polymeric shells comprise at least one acrylic or melamine polymer.

13. The method of claim 11 wherein said polymeric shells have average sizes in the range of from about one micron to about 3 mm.

14. The method of claim 1 wherein said PCM comprises at least one hydrocarbon.

15. The method of claim 1 wherein said PCM comprises at least one natural or synthetic wax.

16. The method of claim 1 wherein said PCM comprises at least one metal inorganic salt hydrate.

17. The method of claim 1 wherein said PCM comprises at least one crystalline polymeric material.

18. The method of claim 1 which is carried out as a continuous production process.

19. The method of claim 1 wherein at least one fire retardant is added to the ingredients.

20. The method of claim 19 wherein said fire retardant material comprises at least one of a magnesium hydroxide and an aluminum hydroxide.

21. The method of claim 1 wherein at least one fibrous reinforcing material is added to the ingredients.

22. The method of claim 2 wherein said viscous mass is subjected to mixing to produce suitable plasticity for shaping into a product through an extrusion process.

23. The method of claim 1 wherein said cementitious binder comprises at least one Portland cement.

24. The method of claim 1 wherein said cementitious binder comprises plaster of Paris.

25. The method of claim 1 wherein said cementitious binder comprises at least one silicate cement,

26. The method of claim 25 wherein said silicate cement comprises at least one of potassium silicate and sodium silicate.

27. The method of claim 1 wherein said cementitious binder comprises at least one acid-base cement.

28. The method of claim 27 wherein said acid-base cement is a chemically bonded phosphate ceramic (CBPC) cement.

29. The method of claim 28 wherein said CBPC is a magnesium phosphate cement.

30. The method of claim 29 wherein said magnesium phosphate cement comprises magnesium oxide and monopotassium phosphate (MKP).

31. The method of claim 27 wherein said acid-base cement comprises a magnesium oxychloride cement.

32. The method of claim 1 wherein said absorbent and/or adsorbent material comprises a clay mineral.

33. The method of claim 32 wherein said clay mineral comprises attapulgite.

34. The method of claim 33 wherein said attapulgite is purified.

35. The method of claim 33 or 34 wherein said attapulgite has maximum particle sizes smaller than about 100 mesh.

36. A method of forming PCM aggregates by processing the ingredients of claim 1, in combination with an effective amount of aqueous liquid, in an agglomerator or pelletizer.

37. A PCM aggregate formed by the method of claim 36.

38. The PCM aggregate of claim 37 which has an enthalpy in the range of from about 35 to about 250 Joules/gram.

39. The PCM aggregate of claim 37 in which the aggregate particles have a generally rounded shape.

40. The PCM aggregate of claim 37 which is sized and graded to a specific fineness modulus to minimize the void space between the particles in bulk.

41. The PCM aggregate of claim 37 wherein the aggregate particles have a non-respirable minimum size of at least about 20 microns.

42. A method of producing a fire resistant PCM extrudite comprising steps of passing the viscous mass of claim 2 or 22 through extruder apparatus.

43. The method of claim 42 wherein the PCM particles in said extrudite are crushed after the extrusion process to form angular-shaped particles having higher specific surface areas.

44. A PCM extrudite produced by the method of claim 42.

45. The PCM extrudite of claim 44 which has an enthalpy in the range of from about 35 to bout 250 Joules/gram.

46. A method of applying a layer of a fire resistant PCM extrudite to a solid planar material using the method of claim 42.

47. A plaster coating prepared by combining a PCM aggregate of claim 37 with at least one plaster and an effective amount of an aqueous liquid.

48. A fire resistant wallboard prepared by combining a PCM aggregate of claim 37 with ingredients comprising a cementitious binder.

49. A concrete product prepared by admixing a PCM aggregate of claim 37 with ingredients comprising at least one cement, at least one mineral aggregate and an effective amount of water.

50. A heat exchange apparatus comprising at least one cylindrical column packed with a bulk PCM aggregate of claim 37 having a fineness modulus effective to permit a predetermined flow of a gas or liquid through said column for heat exchange.

51. A method of producing a fire resistant phase change material (PCM) aggregate, comprising steps of:
providing encapsulated PCM in an aqueous liquid slurry, suspension or emulsion containing an acrylic polymer dispersion; and
combining the PCM slurry, suspension or emulsion with a cementitious binder comprising at least one acid-base cement and a clay mineral in an agglomerator or pelletizer to form PCM aggregate particles in a continuous production process.

52. The method of claim 51 wherein said encapsulated PCM is a microencapsulated PCM (mPCM).

53. A method of producing a fire resistant phase change material (PCM) extrudite, comprising steps of:
providing encapsulated PCM in an aqueous liquid slurry, suspension or emulsion containing an acrylic polymer dispersion;
combining the PCM slurry, suspension or emulsion with a cementitious binder comprising at least one acid-base cement and a clay mineral and mixing to form a viscous mass, adding water as necessary to provide a total moisture content effective to produce a plasticity suitable for extrusion; and
forcing the resulting viscous mass through an extruder head to form an extrudite having a predetermined shape.

54. The method of claims 53 wherein said encapsulated PCM is a microencapsulated PCM (mPCM).
